(19) United States
(12) Patent Application Publication
(10) Pub. No.: US 2026/0359780 A1
(43) Pub. Date: Nov. 12, 2026

(54) INTELLIGENT MONITORED INVENTORY CABINET

(71) Applicant: Intrinsiq Specialty Solutions, Inc., Carrollton, TX (US)

(72) Inventor: Robert Neff, Villanova, PA (US)

(21) Appl. No.: 19/672,636

(22) Filed: May 9, 2026

Related U.S. Application Data
(60) Provisional application No. 63/802,683, filed on May 9, 2025.

(51) Int. Cl. G06Q 10/087

(52) U.S. Cl. CPC G06Q 10/087

(57) ABSTRACT

A medication storage cabinet or a module thereof is provided. The cabinet or module has a compartment defining a storage space and having an opening through which items in inventory are dispensed. A closure may be interconnected to the compartment for being in a locked condition preventing access to the storage space and an unlocked condition permitting access to the compartment. The cabinet or module is associated with a user interface of an electronic inventory management system that receives input concerning dispensing workflow for a stored item in inventory. The electronic inventory management system may also authenticate users and/or automatically control locking/unlocking of the closure and/or movement of the closure from a closed position to an open position. The cabinet or module also includes means for automatically monitoring removal of the item in inventory from the compartment.

### CROSS REFERENCE TO RELATED APPLICATIONS

This application claims the benefit under 35 USC § 119(e) of U.S. Provisional Patent Application No. 63/802,683 filed May 9, 2025.

### BACKGROUND

The present disclosure relates to inventory management systems, including storage cabinets or modules of modular storage cabinets. As an example, storage cabinets and inventory management systems may be provided in healthcare environments, such as specialty physician practices. Alternatively, the storage cabinets may be used in other industries for other goods.

By way of example, medication inventory management systems are used in healthcare environments in order to administer the inventory and distribution of medication and other medical supplies to patients. Medications may be retrieved from a medication storage and/or dispensing cabinet or workstation, placed in patient specific containers, transported to the patient care areas, and administered as prescribed. The cabinets may serve as a workstation from which healthcare professionals can readily access medications or other medical supplies to be administered to the patients under their care.

A typical medication storage and dispensing workstation may comprise a cabinet having a plurality of storage locations, such as drawers, shelves, trays, cassettes, bins, and the like. The storage locations are stocked with individual medications and/or medication doses, or other medical supplies. The contents of the workstations are inventoried and the distribution of medications and medical supplies is carefully controlled.

Access to the medication storage and dispensing cabinet or workstation is typically limited and can be gained only by healthcare professionals with appropriate credentials. A computer-based user interface may enable access to the cabinet or workstation and may be used to record inventory and distribution of medications and/or medical supplies from the cabinet. For instance, after dispensing a medication, a healthcare worker may record a patient's usage into the inventory system and may return any leftover medications to the cabinet. The inventory management system may be used to update and record each transaction.

Such a system eliminates the time required to search for stored medication, as a correct drawer and/or compartment of a cabinet may be readily located. Such a system may also be used to record each transaction and provide an alert when the cabinet requires refilling.

Many inventory management cabinets suffer from the same key flaw, they slow down the user from accessing the inventory due to a door, barrier, or other electronic locking mechanism that prevents users from taking medications which have not been logged and tracked appropriately. In an ideal world, medications would be available unfettered to the user which would greatly reduce the time involved in waiting for doors to open and close, lock and unlock. In many cases, several pieces of inventory required for the same dispensing transaction may be stored behind different locked barriers; this even further slows down the workflow for the user trying to access the inventory.

### SUMMARY

According to an embodiment, a storage cabinet, or a module of a modular storage cabinet, includes a compartment defining a storage space therein and having an opening through which items in inventory stored in the storage space may be dispensed. An electronic inventory management system is associated with the cabinet and includes means for authenticating a credentialled user. The system may include a user interface to receive input concerning dispensing workflow for at least one item in inventory stored in the storage space. The cabinet or module also includes means for automatically monitoring the removal of items in inventory from the compartment and for producing a signal, notification, or alarm if any item in inventory has been removed prior to authorization.

In some embodiments, the opening of the cabinet or module of the cabinet may not include a physical barrier covering the opening of the compartment. In other embodiments, the compartments may include a physical barrier or a closure. Such a closure may be interconnected to the compartment for being positioned between a closed and locked condition in which the closure prevents access to the storage space and an open and unlocked position in which the closure permits access to the storage space. The inventory management system may be configured to automatically control unlocking and locking of the closure. In addition, in some embodiments, the inventory management system by be configured to control movement of the closure from a locked and closed position to an unlocked and open condition to permit access to the storage space to the credentialled user.

According to another embodiment, a method of accessing medicines and medical supplies in a healthcare environment from a medication storage cabinet controlled by a computer controlled medication inventory management system is provided. The method includes authenticating a user, receiving input from the authenticated user concerning dispensing workflow, and automatically detecting removal of a medication or supply from inventory from one or more compartments. The method may further include providing a signal, notification, or alarm if any item in inventory has been removed prior to removal authorization. In some embodiments, the inventory management system may automatically log a removed medication or supply in the inventory management system and/or may automatically unlock and/or open one or more compartments.

### BRIEF DESCRIPTION OF THE DRAWINGS

The foregoing and other objects, features and advantages of the embodiments disclosed herein should become apparent from the following description when taken in conjunction with the accompanying drawings.

FIG. 1 is a perspective view of a module of a cabinet with a door in a closed and locked condition according to an embodiment.

FIG. 2 is a perspective view of the module of a cabinet of FIG. 1 with the door in an open condition according to an embodiment.

FIG. 3 is a flow diagram of an inventory dispense procedure according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known devices, apparatus, methods and structures have not been described in detail so as not to unnecessarily obscure the embodiments.

Embodiments disclosed herein are directed at solving the above referenced problem with conventional inventory management systems. The embodiments disclosed herein provide a cabinet, or a module for a cabinet, and system that tracks and protects inventory without the need for a barrier to slow the inventory from being accessed, and slowing down the user. For purposes of achieving this outcome, the embodiments disclosed herein combine core technology principles working in tandem with each other. These can include physical protection of the inventory along with monitoring of the inventory in the cabinet.

According to embodiments, a user, upon beginning their work shift and/or an inventory dispensing workflow, will cause a cabinet to become physically unlocked and/or the inventory protection physical barriers to be removed. As an example, a permitted user upon approaching a cabinet and becoming authorized (via login, authentication, or the like) will cause the physical doors/barriers of the cabinet to automatically unlock and/or retrack and open. As one example, the door or barrier may be a roll-top door style door (i.e., similar to a typical garage door or the like) that becomes unlocked and/or opens automatically. Of course, other types of barriers, doors, may be utilized.

According to other embodiments, the cabinet or module may not include a physical barrier.

If the cabinet or module does not have a physical barrier, or after the barrier or door is in an unlocked state, the inventory is monitored for access and any changes to inventory state would be attributed to the user who logged into the system. A user is required to complete their inventory dispensing workflow before the user grabs and removes an item or items in inventory off the shelf of the cabinet or module. If any item or items in inventory is/are removed prior to the workflow being completed, a warning, notification, signal, or alarm is activated and an exception may also be logged. A user may have an opportunity with a reasonable amount of time to respond to the alarm or notification by completing the workflow after the fact (to account for the removed inventory). If the user does not respond to the alarm or notification, the cabinet or module may automatically lock and close the door/barrier of the cabinet or module. The user will then be restricted from further access which may include removing electronic access to the system and/or physically locking or replacing the physical barriers.

In a typical dispensing scenario for embodiments disclosed herein, the following steps will be eliminated in the conventional dispensing process, namely, having to wait for a door/barrier to unlock, open the door/barrier, and/or then close the door/barrier. Rather, according to embodiments disclosed herein, the user will simply be able to remove the items from a shelf of a cabinet or the like without physical restriction, such as a locked door or barrier. After some period of time out or upon user logout, the doors or barriers of the cabinet or module, if the cabinet or module has doors, may automatically close and/or return to a locked state.

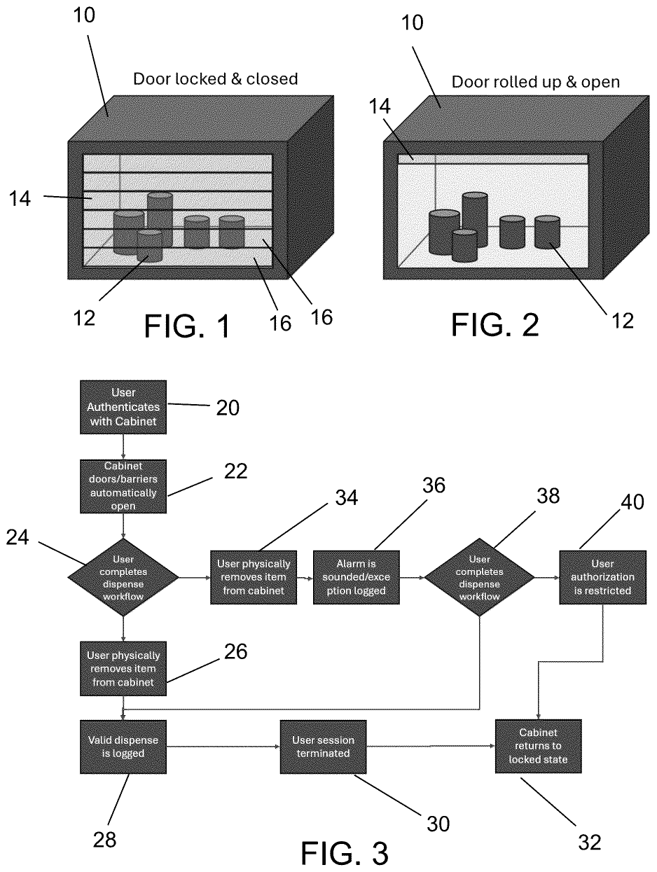

As an example, modular storage cabinets are provided so as to provide a local area to store multiple items required and/or used during daily tasks, such as performed within a healthcare environment. FIG. 1 provides an example of a module 10, part, or shelf of a cabinet. Various vials 12 of medication or the like may be locked and stored within the module, for instance, behind a door 14. FIG. 1 illustrates the module 10 in a locked state in which the vials 12 are not accessible.

The door 14 in the illustrated embodiment is a roll-top door configured by a plurality of segments 16. Of course, module 10 may have other types of doors, barriers, or closures. FIG. 2 shows the module 10 in an unlocked and open condition. In this condition, the vials 12 or other contents are readily accessible to the hand of the user. The door 14 rolls up into the top of the module 10.

According to one embodiment, hardware of the system may include an inventory cabinet or module of a cabinet providing a supply of healthcare supplies. The cabinet may be modular, such that it includes separate modules capable of several configurations. For instance, the cabinet may include a plurality of the modules or compartments 10 as shown in FIGS. 1 and 2 and/or a plurality of arrangeable shelves, bins, dividers, and the like. The cabinet or modules may be electronically operated, monitored, and controlled through a computer module that enables access to authorized users or the like and/or that tracks and manages inventory. In some embodiments, each cabinet module may lock medications, vials, or the like behind doors/barriers with physical locks. In other embodiments, the modules are without physical barriers. According to the illustrated embodiment, the door/barrier may be similar to a roll-up door (i.e., a garage door having multiple hinged sections) or other type of door that can electronically be slide out of place from a locked condition to an open condition. See FIGS. 1 and 2.

The cabinets and/or modules according to some embodiments may include a computer-based user interface or computer that may provide part of an automated inventory management system. By way of example, a computer operating under the direction of a medication inventory management software application program may control the display of the user interface and access to and operation of the cabinet. For example, the interface may be used to permit access to a particular storage unit, enter patient information, record transactions, update inventory, or the like.

Access to storage units or modules may be limited to properly credentialed healthcare professionals by facility protocols. A healthcare professional may gain access to the medication storage units according to established protocols of the facility. Once access is obtained, the healthcare professional should be able to retrieve medication(s) or other medical supplies from the storage units or modules as they are needed or in order to fulfill the prescription requirements of individual patients which are under the care of the healthcare professional.

The inventory management system may comprise an electronic device having at least one non-transitory computer readable storage medium having inventory management computer program instructions stored thereon that, when executed by at least one processor, causes the at least one processor to receive information from an end user entered via of an interface, the information may include an amount or dose of a medication required by a patient treatment plan. By way of example, the electronic device may be a computer or remote or cloud server and may have an interface on or adjacent the cabinet. As an example, the interface may be a touchscreen interface located on or near the cabinet or module.

According to embodiments disclosed herein, the cabinet or module includes technology to automatically monitor removal or access of medications or other items in inventory stored within the cabinet or module. This may occur after a door/barrier is unlocked, removed, and/or opened. Such technology may include, for instance, lasers or other beams or the like able to track physical access across a plane of entry of the module. Other examples may be provided by sensing change of weight of the contents on a shelf or by sensing a thermal change due to the heat of a hand entering the module. Of course, other technologies, such as imaging technologies or the like may also be utilized. As specific examples, the modules may include scales or other sensors on shelves or the like that monitor change in weight or other metrics of removal of material stored in a module or on a shelf within the cabinet. For instance, the modules may include a break-beam sensor, photoelectronic sensor, weight sensor, thermal sensor, or surveillance camera.

The computer software that operates, controls, and/or monitors the cabinet may define, enable, and track workflow, such as a dispensing procedure, for instance, as shown in FIG. 3. In step 20, a user authenticates with a cabinet, for instance, by logging into the system or by the cabinet recognizing the user as an authenticated user (i.e., fingerprint or other biometric, presence of radio frequency badge, barcode, etc.). Accordingly, the cabinet may include a login terminal, fingerprint reader, biometric reader, radio frequency badge reader, barcode reader or the like. Thus, upon approaching a cabinet, the cabinet may automatically recognize the presence of the authenticated user and cause the doors or doors of one or more modules of the cabinet or of the cabinet itself to be unlocked and, in some embodiments, to automatically moved to an open condition. See step 22 in FIG. 3. By way of example, this may be when a user logs in, swipes a badge, uses biometrics, or otherwise identifies oneself to the electronic inventory management system of the cabinet.

Thereafter, the user is required to complete workflow on a computer or interface of the inventory management system that controls operation of the cabinet (see step 24 in FIG. 3) and to remove one or more items from inventory on a shelf or within a module of the cabinet (see step 26). An example of completing workflow may include identifying a patient, medication, dosage, and/or an amount of medication required to be dispensed for a particular patient, prescription, or medical procedure. After the user obtains the required item or items in inventory from the cabinet, the user may be required to scan a barcode or the like of the item/items or otherwise complete inventory dispensing workflow with respect to the item or items removed.

In an example in which the user correctly entered/completed the dispense workflow procedure, the electronic inventory management system may be configured to automatically log and track the dispensed item(s) and consider the dispense workflow to be valid. See step 28 in FIG. 3 Following completion of the valid dispensing workflow, the user's session may be terminated in step 30, such as by user logout or timeout, and the cabinet or module automatically closes the doors/barriers of the modules or cabinet and returns the doors/barriers to a locked state. See step 32.

If a user removes an item from a shelf or module of the cabinet (see step 34) prior to correct and proper completion of inventory dispensing workflow of step 24, an alarm, notification, signal, or warning is activated or sent in step 36. The alarm or notification may include a warning on a computer screen or interface which prompts the user to complete workflow. The alarm may also include an actual siren or the like. Thus, since step 24 was not correctly accomplished and completed, the system will cause an alarm to be sounded and/or notification to be issued and, in some embodiments, an exception to be logged in the inventory management system. In response to the alarm or notification, a user may proceed to complete the dispense workflow on the computer or an interface of the inventory management system (see step 38), and if accurate, the items dispensed will be logged as valid in step 28. Thereafter, the user's session will be terminated and the cabinet will be returned to a closed and locked state.

If a user skips step 24 or enters inaccurate information and the system causes an alarm to be sounded and/or notification to be issued in step 36 and the user does not complete the dispense workflow on the computer or an interface of the inventory management system, the user's authorization to access the cabinet will be restricted (see step 40) and logged and the cabinet will be automatically returned to a closed and locked state.

In FIG. 3 and the above described dispense workflow, a simple single inventory dispense interaction is illustrated. However, in reality, each workflow may require several dispense transactions that take place once the user has been authenticated and the cabinet is automatically in the unlocked and accessible mode.

In some embodiments, the medication inventory management software application program may control which of the modules or the like is unlocked and/or opened based upon the information entered for the dispense workflow. Thus, upon entering patient information or drug information for dispensing of a particular medication or the like, the inventory system may cause only certain of the doors or barriers to be unlocked and/or opened while others remain closed and/or locked. In this manner, the worker is readily informed of the particular shelf and/or the particular module in which the required medication is located. Accordingly, the automatic unlocking and/or opening of one or may selected doors may help guide the user to the correct shelf or module.

In some embodiments, the cabinet or modules may include any arrangement of a kiosk style thermal printer or the like (i.e., for printing labels and/or receipts), a multi-read barcode scanner or the like, a limited access drawer (i.e., for narcotics or high value products), or the like. The cabinets may include an integral forwardly-extending work surface or workspace and/or may include a scanner (such as a barcode scanner or the like).

A system for carrying out any of the above disclosed embodiments, methods, or arrangements may include software or the like provided on a circuit board or within another electronic device such as a remote or cloud server and can include various processors, microprocessors, modules, units, components, controllers, chips, disk drives, and the like. It will be apparent to one of ordinary skill in the art that systems, modules, components, units, processors, servers, and the like may be implemented as electronic components, software, hardware or a combination of hardware and software for purposes of providing a system.

Embodiments may also include at least one non-transitory computer readable storage medium having computer program instructions stored thereon that, when executed by at least one processor, can cause the at least one processor to perform any of the steps described above.

The foregoing description and specific embodiments are merely illustrative of the principles thereof, and various modifications and additions may be made to the apparatus by those skilled in the art, without departing from the spirit and scope of this invention.

We claim:

1. A storage cabinet or module thereof, comprising:
a compartment defining a storage space therein and having an opening through which items in inventory stored in the storage space are dispensed;
an electronic inventory management system including means for authenticating a credentialled user and having a user interface for receiving input concerning dispensing workflow for at least one of the items stored in the storage space; and
means for automatically monitoring removal of one or more of the items in inventory from the compartment.

2. The storage cabinet or module thereof according to claim 1, further comprising:
a closure interconnected to the compartment for being positioned between a locked condition preventing access to the storage space and an unlocked condition permitting access to the compartment;
wherein the electronic inventory management system includes means for automatically controlling the closure to change from the locked condition to the unlocked condition to permit access to the storage space to the credentialled user.

3. The storage cabinet or module thereof according to claim 2, wherein said means for automatically controlling the closure from changing from the locked condition to the unlocked condition also automatically controls movement of the closure from a closed position to an open position when unlocked.

4. The storage cabinet or module thereof according to claim 2, wherein the electronic inventory management system automatically causes the closure to move from an unlocked and open position to a locked and closed position upon completion of the dispensing workflow.

5. The storage cabinet or module thereof according to claim 1, wherein the items are medicine or medical supplies.

6. The storage cabinet or module thereof according to claim 2, wherein the closure is a door.

7. The storage cabinet or module thereof according to claim 6, wherein the door is a roll-top door including a plurality of hinged segments.

8. The storage cabinet or module thereof according to claim 2, wherein the storage cabinet or module thereof includes a plurality of compartments each having a closure.

9. The storage cabinet or module thereof according to claim 8, wherein the electronic inventory management system controls unlocking or opening of only a selected one or ones of the plurality of compartments based on the entered workflow.

10. The storage cabinet or module thereof according to claim 1, wherein said means for authenticating the credentialled user is selected from the group consisting of computer login, fingerprint reader, biometric reader, radio frequency badge reader, and barcode reader.

11. The storage cabinet or module thereof according to claim 1, wherein the user interface communicates with an electronic device having at least one non-transitory computer readable storage medium having inventory management computer program instructions stored thereon.

12. The storage cabinet or module thereof according to claim 1, wherein said workflow includes identifying at least one of a patient, treatment, medication, and dosage.

13. The storage cabinet or module thereof according to claim 1, wherein said means for automatically monitoring removal of the at least one item from the compartment is selected from the group consisting of a break-beam sensor, photoelectronic sensor, weight sensor, thermal sensor, surveillance camera, and any sensor or means for detecting removal of an item for a physical space.

14. The storage cabinet or module thereof according to claim 1, further comprising a signal activatable by the electronic inventory management system if an item is removed from the compartment that is not associated with the workflow.

15. A method of accessing medicines and medical supplies in inventory in a healthcare environment from a medication storage cabinet or a module thereof controlled by a computer controlled medication inventory management system, comprising the steps of:
authenticating a user;
receiving input from the authenticated user concerning dispensing workflow; and
automatically detecting removal of a medication or medical supply in inventory from one or more compartments of the storage cabinet or module thereof.

16. The method according to claim 15, further comprising the steps of automatically unlocking or opening the one or more compartments of the medication storage cabinet after said authenticating step or said receiving step, and automatically logging the removed medication or medical supply in inventory in the inventory management system after said detecting step.

17. The method according to claim 16, further comprising the step of automatically causing the one or more compartment to be closed or locked after completion of the workflow.

18. The method according to claim 16, wherein the computer controlled medication inventory management system controls unlocking or opening of only a selected one or ones of the one or more compartments of the medication storage cabinet or module thereof based on the entered workflow.

19. The method according to claim 15, wherein said authenticating step includes at least one of computer login, fingerprint detection, biometric detection, radio frequency badge detection reader, and barcode detection, wherein said workflow includes identifying at least one of a patient, treatment, medication, and dosage, and wherein said step of automatically detecting removal of a medication includes break-beam sensing, photoelectronic sensing, weight sensing, thermal sensing, or image sensing.

20. The method according to claim 15, further comprising the step of activating an alarm or notification upon detection of removal of an item in inventory from the one or more compartments that is not associated with the entered workflow.
